(19) United States
(12) Patent Application Publication
(10) Pub. No.: US 2025/0370399 A1
(43) Pub. Date: Dec. 4, 2025

(54) REGENERATION DEVICE FOR CLEANING BLADE, REGENERATION METHOD FOR CLEANING BLADE, AND MANUFACTURING METHOD FOR REGENERATED CLEANING BLADE

(71) Applicant: CANON KABUSHIKI KAISHA, Tokyo (JP)

(72) Inventors: KATSUYA KODAMA, Kanagawa (JP); HIDEKAZU MATSUDA, Shizuoka (JP); TAKEHIKO AOYAMA, Shizuoka (JP)

(21) Appl. No.: 19/299,590

(22) Filed: Aug. 14, 2025

Related U.S. Application Data
(63) Continuation of application No. PCT/JP2024/005943, filed on Feb. 20, 2024.

(30) Foreign Application Priority Data
Feb. 21, 2023 (JP) 2023-025320

(51) Int. Cl. G03G 21/00; B26D 3/00; B26D 7/02

(52) U.S. Cl. CPC G03G 21/0017; B26D 3/003; B26D 7/02; G03G 21/0029

(57) ABSTRACT

A regeneration device for a cleaning blade provided in an electrophotographic image forming apparatus, wherein the cleaning blade includes a blade portion for cutting the tip of an elastic member in a longitudinal direction of the elastic member, and the regeneration device moves the blade portion relatively from one end A of the elastic member in its longitudinal direction toward the other end B to cut a portion of the tip of the elastic member, the regeneration device includes a clamping member for clamping at least a part of the elastic member under specified conditions from both sides of the elastic member, a biasing member that contacts and biases the end B of the elastic member, and a pressing member that presses the tip of the elastic member, and the pressing member presses the tip of the elastic member prior to the movement.

### CROSS-REFERENCE TO RELATED APPLICATIONS

This application is a Continuation of International Patent Application No. PCT/JP2024/005943, filed Feb. 20, 2024, which claims the benefit of Japanese Patent Application No. 2023-025320, filed Feb. 21, 2023, both of which are hereby incorporated by reference herein in their entirety.

### BACKGROUND

### Field of the Technology

The present disclosure is directed to a regeneration device and a regeneration method for cleaning blades arranged in electrophotographic image forming apparatus and a method for manufacturing regenerated cleaning blades.

### Description of the Related Art

In electrophotographic image forming apparatuses such as electrophotographic copiers and laser beam printers, for example, cleaning blades are used to remove residual toner remaining on a photosensitive drum after transfer. Cleaning blades that have been used for a long period of time may have worn edges at the tip of the cleaning blade that contacts a cleaning target member such as a photosensitive drum, or may have many fine defects. Japanese Patent Laid-Open No. 08-254931 discloses a method for regenerating cleaning blades by cutting off the tip-side edge of the edge of a cleaning blade that has been collected after use. Japanese Patent Laid-Open No. 08-254931 also describes a specific method for regenerating cleaning blades, in which the tip-side edge is cut with a blade.

### SUMMARY

Based on Japanese Patent Laid-Open No. 08-254931, the present inventors cut off the tip-side edge of a cleaning blade using a razor and regenerated the cleaning blade. However, the cleaning performance of the regenerated cleaning blade obtained as a result was far from satisfactory.

Therefore, at least one aspect of the present disclosure is directed at providing a regeneration device for cleaning blades that can regenerate a cleaning blade with reduced wiping performance with high precision. In addition, at least one aspect of the present disclosure is directed at providing a regeneration method for cleaning blades, that restores the wiping performance of a cleaning blade with reduced wiping performance. Furthermore, at least one aspect of the present disclosure is directed at providing a method for manufacturing regenerated cleaning blades with wiping performance equivalent to that of new cleaning blades.

According to at least one embodiment of the present disclosure, there is provided a regeneration device for a cleaning blade provided in an electrophotographic image forming apparatus, wherein the cleaning blade comprises an elastic member and a support member that supports the elastic member, when a side of the cleaning blade that contacts a surface of a cleaning target member is defined as a tip side of the cleaning blade, the elastic member has a plate-shaped portion at least at the tip side, which has a main surface that faces the cleaning target member and a tip surface that forms a tip-side edge together with the main surface, the regeneration device comprises a blade portion for cutting at least a portion of the elastic member including the tip surface in a longitudinal direction of the elastic member, the regeneration device is configured to cause the blade portion to enter into the elastic member from a side portion of the plate-shaped portion of the elastic member at one end A in the longitudinal direction of the elastic member to move relatively toward the other end B in the longitudinal direction, thereby cutting at least the portion of the elastic member including the tip surface, the regeneration device comprises: a clamping member for the elastic member; a biasing member that contacts the end B of the elastic member and biases the elastic member in a direction toward the end A; and a pressing member that presses at least a portion of the tip surface of the elastic member, the clamping member is configured to clamp at least a portion of the elastic member from both side portions of the elastic member in a cross-sectional view taken in a direction perpendicular to the longitudinal direction of the elastic member, the clamping member is disposed at a position where it can clamp at least a portion of the elastic member into which the blade portion enters, and a position of the clamping member relative to the elastic member is fixed, and the pressing member presses at least a portion of the tip surface of the elastic member toward a side opposite to the tip side of the elastic member prior to the relative movement of the blade portion from the end A to the end B.

Also, according to at least one embodiment of the present disclosure, there is provided a regeneration method for a cleaning blade provided in an image forming apparatus using an electrostatic transfer process, wherein the cleaning blade comprises an elastic member and a support member that supports the elastic member, the method comprising: a step of fixing the elastic member to the regeneration device for the cleaning blade; and a step of cutting at least a portion of the elastic member including the tip surface by the regeneration device.

Also, according to at least one embodiment of the present disclosure, there is provided a manufacturing method for a regenerated cleaning blade, which is for regenerating a cleaning blade provided in an image forming apparatus using an electrostatic transfer process, wherein the cleaning blade comprises an elastic member and a support member that supports the elastic member, and the method comprises a step of fixing the elastic member to the regeneration device; and a step of cutting at least a portion of the elastic member including the tip surface by the regeneration device to obtain the regenerated cleaning blade.

Features of the present disclosure will become apparent from the following description of embodiments with reference to the attached drawings.

### BRIEF DESCRIPTION OF THE DRAWINGS

FIG. 1A and 1B are schematic diagrams of a cleaning blade.

FIG. 2A to 2C are diagrams for explaining deformation of an elastic member.

FIG. 3A and 3B are diagrams for explaining deformation of an elastic member.

FIG. 4A and 4B are diagrams for explaining deformation of an elastic member.

FIG. 5 is a diagram for explaining deformation of an elastic member.

FIG. 6 is a schematic diagram of an elastic member regeneration device.

FIG. 7A and 7B are schematic diagrams for explaining a cutting unit.

FIG. 8A and 8B are schematic diagrams for explaining a cutting unit and a clamping member.

FIG. 9A and 9B are diagrams for explaining a clamping member.

FIG. 10A and 10B are diagrams for explaining a pressing member.

FIG. 11A and 11B are diagrams for explaining a biasing member.

FIG. 12 is an enlarged view further illustrating a blade portion and the vicinity of the tip of an elastic member.

FIG. 13 is a diagram for explaining a biasing member.

FIG. 14A and 14B are diagrams for explaining a biasing member.

### DESCRIPTION OF THE EMBODIMENTS

Unless otherwise specified, descriptions of numerical ranges such as “from XX to YY” or “XX to YY” in the present disclosure include the numbers at the upper and lower limits of the range. When numerical ranges are described in stages, the upper and lower limits of each of each numerical range may be combined arbitrarily. In the present disclosure, wording such as “at least one selected from the group consisting of XX, YY and ZZ” means any of: XX; YY; ZZ; a combination of XX and YY; a combination of XX and ZZ; a combination of YY and ZZ; or a combination of XX and YY and ZZ.

A cleaning blade according to the present disclosure is used, for example, for cleaning a cleaning target member in an electrophotographic image forming apparatus. Examples of the cleaning target member include, but are not limited to, a photosensitive drum, a developing roller, a charging roller, and an intermediate transfer belt.

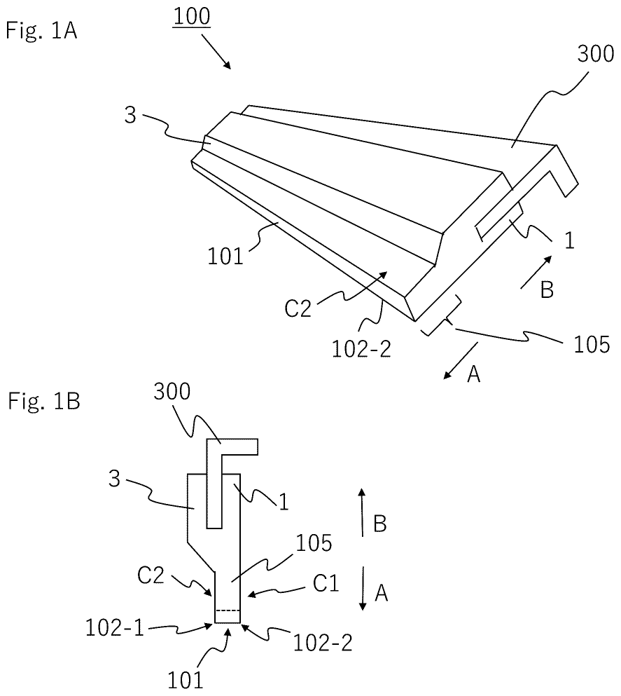

An example of a cleaning blade is shown in FIGS. 1A and 1B. FIG. 1A shows the entire cleaning blade, and FIG. 1B shows a cross-sectional view of a cleaning blade 100 in a direction perpendicular to the longitudinal direction. The cleaning blade 100 includes an elastic member 3 and a support member 300 that supports the elastic member 3. The side of the cleaning blade that contacts the surface of a cleaning target member (not shown), that is, the side indicated by arrow A in FIG. 1A, is defined as the tip side of the cleaning blade. The elastic member 3 has, at least on the tip side, a plate-shaped portion 105 having a main surface C1 that faces the cleaning target member (not shown) and a tip surface 101 that forms a tip-side edge 102-2 together with the main surface C1. Further, a surface C2 of the plate-shaped portion 105 on a side opposite to the main surface C1 constitutes a tip-side edge 102-1 together with the tip surface 101.

The regeneration device according to the present disclosure cuts at least a portion of the elastic member 3 including the tip surface 101. The tip after cutting may not include the tip surface 101. For example, a new tip surface may be formed by cutting parallel to the tip surface 101 at the position indicated by the dotted line in FIG. 1B.

It should be noted that either the tip-side edge 102-1 or the tip-side edge 102-2 may come into contact with the cleaning target member, and there is no particular limitation. In addition, in FIG. 1B, the width of the elastic member 3 is different between a base portion 1 side and a free end side, but the present disclosure is not limited to this embodiment, and for example, both may have the same width.

As described above, the present inventors produced a regenerated cleaning blade by cutting the tip-side edge of a used cleaning blade with a razor according to Japanese Patent Laid-Open No. 08-254931. However, the cleaning performance of the obtained regenerated cleaning blade was lower than that of a new cleaning blade. The reasons for this are considered to be as follows. The contact portion of the cleaning blade with the cleaning target member is flexible to provide elasticity. When the flexible tip portion is cut with a razor, the cut surface of the tip portion may be deformed during various steps of the cutting process. This is thought to cause a decrease in the cleaning performance of the regenerated cleaning blade. A detailed explanation is given below.

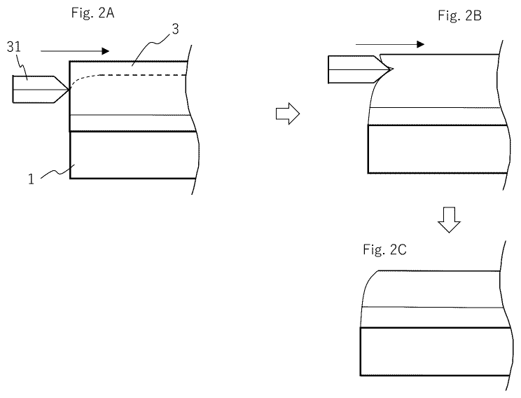

First, the blade portion of the razor is brought into contact with the side surface at one end side of the elastic member 3 (see FIG. 2A), and then the blade portion is caused to enter into the elastic member. At this time, the pressure of the blade portion when it enters may cause the side surface of the elastic member to elastically deform as shown in FIG. 2B. As a result, as shown in FIG. 2C, the end of the elastic member after cutting forms an R-surface. A regenerated cleaning blade with such a shape may cause toner to slip through the end surface.

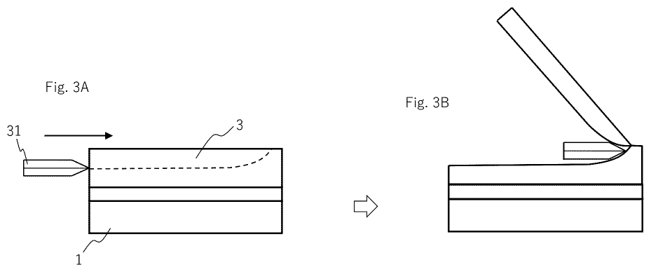

Next, the blade portion is caused to enter from the side surface at one end side of the elastic member, and the cutting of the tip of the elastic member is advanced while moving the blade portion toward the other end side of the elastic member in the longitudinal direction. At this time, as indicated by the dotted line in FIG. 3A, as the blade portion advances from one end of the elastic member to the other end, the advancing direction of the blade portion deviates upward, and the cleaning blade after cutting may have a shape as shown in FIG. 3B. Such deviation in the advancing direction of the blade portion became more pronounced as the thickness of the portion of the elastic member to be cut was reduced. The deviation in the advancing direction of the blade portion is thought to be due to the fact that the force applied to the blade portion to advance the blade portion is likely to be directed upward because the portion of the elastic member to be cut is thin.

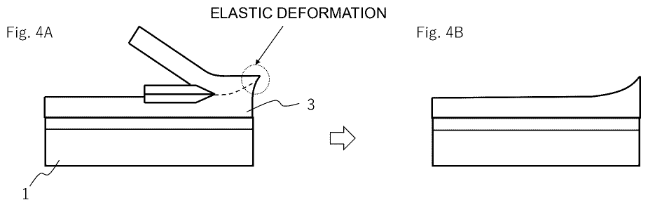

Finally, even if the blade portion can be advanced to the other end side of the elastic member, as shown in FIG. 4A, as the blade portion approaches the side surface on the other end side of the elastic member, the end of the elastic member on the other end side may elastically deform. This elastic deformation is thought to be particularly likely to occur because the elongation on the tip side of the elastic member 3 is greater than that of the base portion 1 side of the elastic member 3. The elongation of this elastic deformation also causes the advancing direction of the blade portion to deviate upward, and the other end side of the regenerated cleaning blade may have a burr as shown in FIG. 4B.

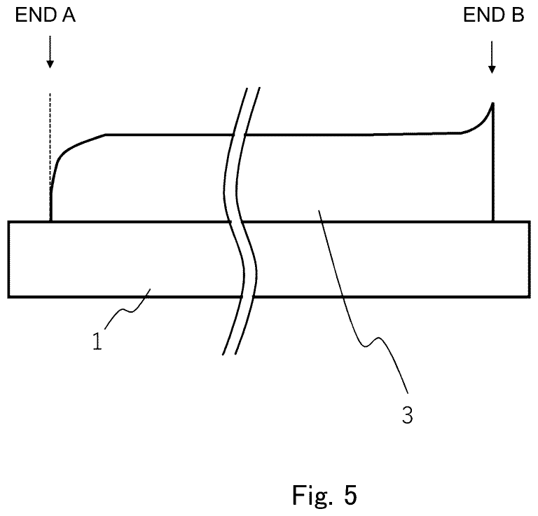

As described above, there are reasons why the shape of the tip portion of the regenerated cleaning blade is deformed in each process at the beginning, during, and end of cutting. As a result, for example, as shown in FIG. 5, a regenerated cleaning blade may be obtained in which the cut surface has an S-shaped curve from one end side (end A) to the other end (end B). The inventors of the present invention have conducted research to develop a regenerated cleaning blade that prevents deformation of the cut surface during each manufacturing step of the regenerated cleaning blade, that is, when cutting the elastic member, enabling higher precision regeneration of the elastic material while achieving wiping performance equivalent to that of new cleaning blades. As a result, the present inventors have come to find the following regeneration device for cleaning blades, regeneration method for cleaning blades, and manufacturing method for regenerated cleaning blades.

One embodiment of the regeneration device for an elastic member according to the present disclosure relates to a regeneration device for a cleaning blade provided in an electrophotographic image forming apparatus, wherein the cleaning blade comprises an elastic member and a support member supporting the elastic member, when a side of the cleaning blade that contacts a surface of a cleaning target member is defined as a tip side of the cleaning blade, the elastic member has a plate-shaped portion at least at the tip side, which has a main surface that faces the cleaning target member and a tip surface that forms a tip-side edge together with the main surface, the regeneration device comprises a blade portion for cutting at least a portion of the elastic member including the tip surface in a longitudinal direction of the elastic member, the regeneration device is configured to cause the blade portion to enter into the elastic member from a side portion of the plate-shaped portion of the elastic member at one end A in the longitudinal direction of the elastic member to move relatively toward the other end B in the longitudinal direction, thereby cutting at least the portion of the elastic member including the tip surface, and the regeneration device further comprises: a clamping member that clamps at least a portion of the elastic member from both side portions of the elastic member in a cross-sectional view taken in a direction perpendicular to the longitudinal direction of the elastic member; a biasing member that contacts the end B of the elastic member and biases the elastic member in a direction toward the end A; and a pressing member disposed on the tip surface of the elastic member to press the tip prior to the movement of the blade portion and prevent an advancing direction of the blade portion from deviating toward the tip side due to the movement of the blade portion.

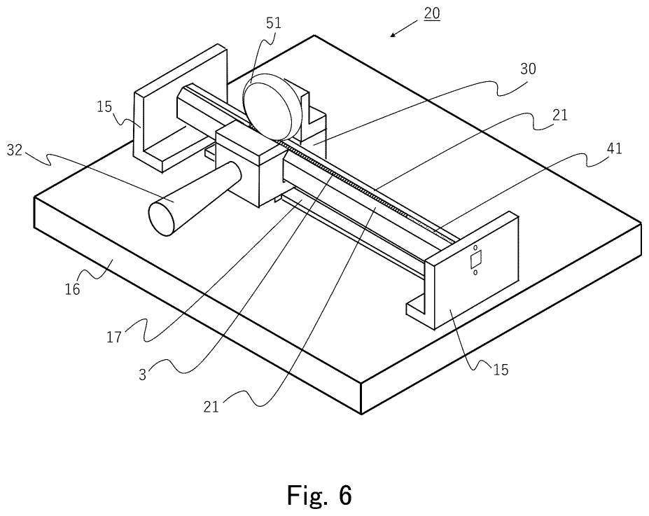

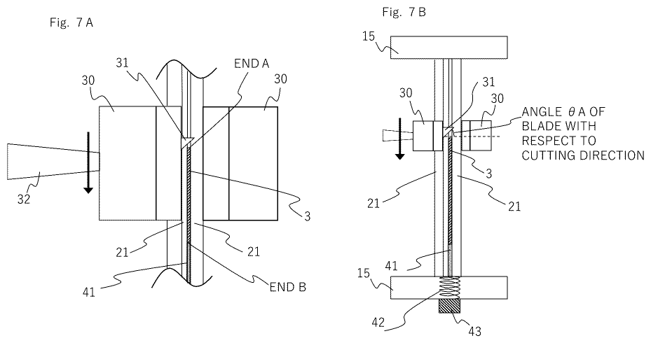

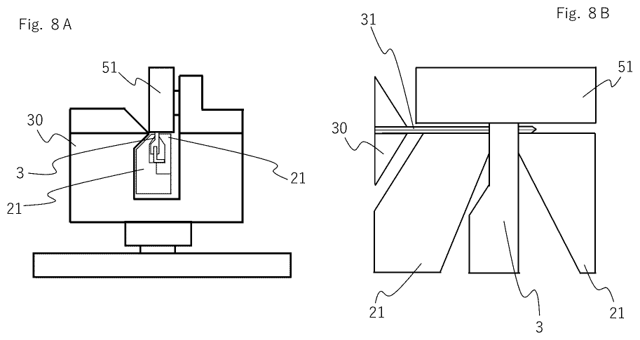

A regeneration device for cleaning blades according to one embodiment of the present disclosure will be described with reference to FIGS. 6, 7A, 7B, 8A, and 8B. FIG. 6 is a schematic diagram showing the appearance of a cleaning blade regeneration device 20. FIGS. 7A and 7B are schematic diagrams explaining a cutting unit 30 equipped with a blade portion and a cutting movement. FIG. 8A is a cross-sectional view of the cutting unit 30 and a clamping member 21 in the lateral direction of the elastic member, and FIG. 8B is an enlarged view of the vicinity of the blade portion 31.

The cleaning blade regeneration device 20 includes an elastic member clamping member 21 as an elastic member fixing member for fixing the elastic member 3. The clamping member 21 fixes the elastic member by clamping the elastic member 3 from the lateral direction of the elastic member. For example, the elastic member is clamped from the left-and-right direction in FIG. 1B. That is, the clamping member 21 clamps at least a portion of the elastic member 3 from both side portions of the elastic member 3 in a cross-sectional view perpendicular to the longitudinal direction of the elastic member (FIGS. 8A and 8B). For example, the clamping member 21 clamps the plate-shaped portion 105.

In FIG. 6, the clamping member 21 is fixed on the base 16 by a holding member 15 having an L-shaped cross-section in the longitudinal direction of the cleaning blade and the elastic member.

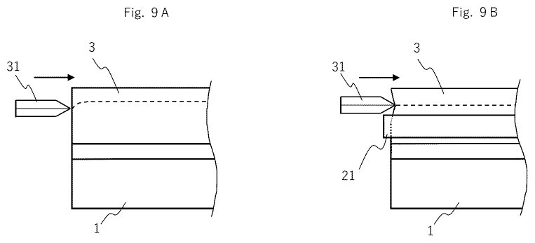

As shown in FIG. 8B (enlarged view on the right) and FIG. 9B, the clamping member 21 is disposed at a position where it can clamp at least a portion (end A) where the blade portion 31 enters into the elastic member 3. In the figure, the clamping member 21 clamps the entire longitudinal region of the elastic member 3 from both side portions, including the portion where the blade portion 31 enters. The position of the clamping member relative to the elastic member is fixed. The manner in which the cleaning blade is applied to the regeneration device is not particularly limited. As shown in FIG. 8A, the cleaning blade having the elastic member and the support member may be applied to the regeneration device, or the cleaning blade having the elastic member removed from the support member may be applied to the regeneration device.

The elastic member regeneration device 20 has the blade portion 31 for cutting at least a portion of the elastic member including the tip surface in the longitudinal direction of the elastic member 3. For example, as shown in FIGS. 6, 7A, and 7B, the elastic member regeneration device 20 may have a cutting unit 30, and the cutting unit 30 may have the blade portion 31 (not shown in FIG. 6).

The cutting unit 30 is movable along the longitudinal direction of the elastic member 3 and the clamping member 21. In FIG. 6, the cutting unit 30 can move along a rail 17 that guides the movement. For example, in FIG. 6, the cutting unit 30 is movable manually by means of a handle 32, but it may be driven by an electric cylinder, a motor, or the like rather than manually.

It is to be noted that, in order to facilitate the movement of the cutting unit 30, the cutting unit 30 and the clamping member 21 may be non-contacting.

FIGS. 7A and 7B are overhead views of the cutting unit 30 in the elastic member regeneration device 20 as seen from above the device. FIG. 7A is an enlarged view of the cutting unit 30, and FIG. 7B is a view of the entire cleaning blade in the longitudinal direction, including the clamping member 21. The cutting unit 30 equipped with the blade portion 31 moves from an end A to an end B in the direction indicated by arrow in the figure along the longitudinal direction of the elastic member 3.

Then, the blade portion 31 is caused to enter into the elastic member 3 from the side portion of the plate-shaped portion of the elastic member 3 at the end A, which is one end of the elastic member 3 in the longitudinal direction, and is moved relatively toward the end B, which is the other end in the longitudinal direction, thereby cutting at least a portion of the elastic member 3 including the tip surface. By cutting in this manner, the worn or deteriorated portion can be removed, and a regenerated cleaning blade can be obtained.

In the illustrated regeneration device 20, the blade portion 31 (cutting unit 30) moves, but it is sufficient that the blade portion 31 can move relatively from the end A to the end B. In other words, the cutting unit 30 equipped with the blade portion 31 may be fixed, and the clamping member 21 to which the elastic member 3 is fixed may move. For example, it is preferable that the blade portion 31 moves so as to cut the tip-side edge 102-1, the tip-side edge 102-2, and the tip surface 101. Preferably, the blade portion 31 cuts the elastic member 3 at, for example, the position indicated by the dotted line in FIG. 1B so that a surface parallel to the tip surface 101 to be cut appears.

Furthermore, as shown in FIGS. 7A and 7B, the regeneration device 20 includes a biasing member 41 that contacts the side portion of the tip of the elastic member 3 at the end B of the elastic member 3 and biases the elastic member in the direction toward the end A. The biasing member 41 is, for example, a plate-shaped member, and is inserted into the gap of the clamping member 21. The biasing member 41 presses the end B of the elastic member from the end of the clamping member 21 in the direction toward the end A by the elastic member 42 such as a spring.

As shown in FIGS. 6, 8A, and 8B, the regeneration device 20 includes a pressing member 51 that presses at least a portion of the tip surface of the elastic member 3 (for example, toward the base portion 1 of the elastic member 3). The pressing member 51 presses at least a portion of the tip surface 101 of the elastic member 3 toward the side opposite to the tip side of the elastic member 3 (in the direction indicated by arrow B in FIGS. 1A and 1B) prior to the relative movement of the blade portion 31 from the end A to the end B. In this way, the advancing direction of the blade portion 31 is prevented from deviating toward the tip surface side (in the direction indicated by arrow A in FIGS. 1A and 1B) due to the movement of the blade portion 31.

For example, as shown in FIGS. 6 and 8A, the pressing member 51 is provided in the cutting unit 30 and can move in accordance with the movement of the blade portion 31.

The inventors consider the following reasons why the elastic member regenerating device 20 can suppress deformation of the cut surface of the elastic member 3 and can obtain a higher-precision regenerated elastic member.

The suppression of deformation at the beginning of cutting will be explained. The regeneration device 20 includes the clamping member 21 that clamps the elastic member 3 from both side portions in the lateral direction of the elastic member 3. The clamping member 21 is disposed in a position where it can clamp at least a portion of the elastic member 3 into which the blade portion 31 enters, and the position of the clamping member relative to the elastic member is fixed. In other words, unlike the razor or the like used in Japanese Patent Laid-Open No. 08-254931, in the regeneration device 20, the clamping member 21 clamps the elastic member 3 without moving relative to the elastic member 3 even when the blade portion 31 moves.

In this way, it is believed that the portion of the elastic member 3 into which the blade portion 31 enters is clamped, whereby the elastic deformation of the elastic member 3 caused by the pressure when the blade portion 31 is caused to enter into the side portion of the elastic member 3 is suppressed. As a result, it is possible to prevent the end of the elastic member on the entry side where the blade portion 31 enters after cutting from forming an R-surface.

For example, when the clamping member 21 is not present, as shown in FIGS. 2 and 9A, the elastic deformation of the elastic member 3 may cause the end on the entry side where the blade portion 31 enters to form an R-surface, as indicated by the dashed line. Alternatively, when the thickness to be cut (cutting allowance) is small, it may be difficult to insert the blade portion 31 into the elastic member 3. On the other hand, as shown in FIG. 9B, when the clamping member 21 that clamps the elastic member 3 from both side surfaces is present, it is considered that excessive elastic deformation is suppressed, and pressure is uniformly applied to the elastic member 3. As a result, it is considered that deformation of the cut surface can be suppressed as indicated by the dashed line.

In order to suppress deformation at the entry portion where the blade portion 31 enters, it is sufficient that the clamping member 21 clamps at least the portion into which the blade portion 31 enters. The clamping member 21 may clamp the elastic member 3 over the entire longitudinal region of the elastic member 3, as shown in FIGS. 7A and 7B.

Next, suppression of elastic deformation caused by flipping up of cut pieces during cutting will be described. The regeneration device 20 includes a pressing member 51 that presses at least a portion of the tip surface of the elastic member 3 prior to the relative movement of the blade portion 31 from the end A to the end B. The pressing member 51 prevents the advancing direction of the blade portion 31 from deviating toward the tip surface (the direction indicated by arrow A in FIGS. 1A and 1B) due to the movement of the blade portion 31. Since the pressing member 51 can press the elastic member 3 at a position just before the blade portion 31 cuts, it is considered that the elastic deformation of the elastic member 3 caused by the cut pieces flipping up by the blade portion 31 can be suppressed. As a result, the cutting advancing direction of the blade portion 31 is less likely to change, and deformation of the cut surface can be suppressed.

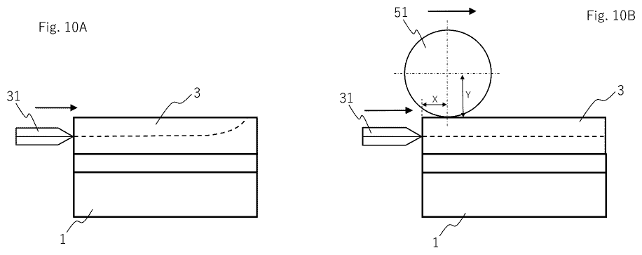

For example, if the pressing member 51 is not present, the cutting advancing direction changes due to the elastic deformation of the elastic member 3 as shown in FIGS. 3A, 3B, and 10A, and the cut surface curves as indicated by the dashed line. On the other hand, in FIG. 10B, the pressing member 51 moves ahead of the blade portion 31 in the direction indicated by arrow while pressing the elastic member 3 toward the side opposite to the tip side (toward the base portion 1) together with the blade portion 31. That is, the regeneration device 20 performs cutting while suppressing elastic deformation caused by the movement of the blade portion 31 with the pressing member. This makes it difficult for the elastic member 3 to elastically deform, and it is considered that deformation of the cut surface can be suppressed as indicated by the dashed line. For example, the pressing member 51 and the blade portion 31 move while maintaining a constant distance between the tip of the blade portion 31 and the pressing member 51.

Furthermore, suppression of deformation at the end in the latter half of cutting will be described. The regeneration device 20 has the biasing member 41 that contacts the side portion of the end B of the elastic member 3 and biases the elastic member toward the end A. Such a biasing member 41 can suppress elongation due to elastic deformation of the end B at the tip side of the elastic member, thereby suppressing the deformation of the cut surface.

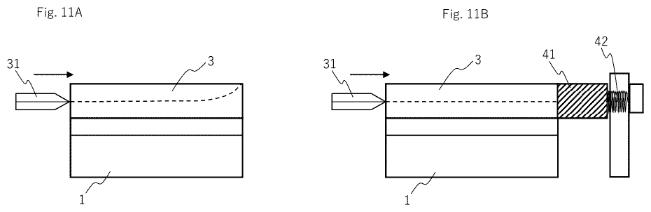

For example, if the biasing member 41 is not present, as shown in FIGS. 4A, 4B, and 11A, the elastic deformation on the tip side of the end of the elastic member becomes large, and the cut surface curves as indicated by the dashed line. On the other hand, when the biasing member 41 is present as shown in FIG. 11B, the elastic deformation of the end of the elastic member, particularly the elongation on the free end side (tip side) opposite the base portion 1, can be suppressed, and it is considered that the deformation of the cut surface can be suppressed as indicated by the dashed line.

It is considered that the pressing member 51 is effective in preventing the elastic deformation of the elastic member 3 caused by the flipping up of the cut pieces even at the trailing end of such a cut portion. However, it is considered that the pressing member 51 alone is insufficient to suppress the elastic deformation in the cutting direction (longitudinal direction of the elastic member). Therefore, the pressing member 51 and the biasing member 41 are important in order to sufficiently suppress the deformation of the trailing end of the cut portion.

As described above, by using a specific clamping member, pressing member, and biasing member, it is considered possible to suppress the elastic deformation of the elastic member in the process of cutting the tip of the elastic member by inserting the blade portion into the elastic member from the end A and moving the blade portion relatively toward the end B, thereby suppressing the deformation of the cut surface of the elastic member. Therefore, it is possible to suppress the cut surface from forming an S-shaped curve as shown in FIG. 5, and the elastic member can be regenerated with higher precision.

In addition, as a cutting method, freezing cutting that eliminates or reduces the elasticity of the elastic member, and laser cutting and water jet cutting that cut before elastic deformation occurs by extremely increasing the cutting force are also considered. However, the above-mentioned regeneration device 20 reduces the device cost, is highly mass-productive, and enables high-precision regeneration compared to such cutting methods.

The following describes each component of the elastic member regeneration device 20.

The regeneration device 20 has the blade portion 31. It is sufficient that the blade used for the blade portion 31 can cut the elastic member by relative movement. The angle of the blade with respect to the lateral direction of the elastic member 3 (blade angle θA) is not particularly limited, and the blade portion 31 may be attached to the regeneration device 20 so that the blade angle is preferably 20 to 70°, more preferably 30 to 60°, and even more preferably 40 to 50°. FIGS. 7A and 7B show an example in which the blade angle θA is 45°.

When the regeneration device 20 is viewed in cross-section in the longitudinal direction of the elastic member, the angle θB (not shown) between the longitudinal direction of the elastic member 3 (for example, the horizontal plane of the device) and the direction perpendicular to the blade length direction and parallel to the blade body is preferably 0 to 10°, more preferably 2 to 8°, and even more preferably 3 to 7°, with the case where the cutting edge faces the base portion 1 side being positive. The angle θB being within the above range means that the blade is slightly inclined toward the base portion 1 side of the elastic member. Due to this, the cut pieces are likely to flip up toward the side opposite to the advancing direction of the blade portion.

The blade may be double-edged or single-edged. In the regeneration device 20 shown in FIG. 6 and the like, a double-edged blade is used as the blade portion 31.

The blade thickness is not particularly limited, and is preferably 0.05 to 0.50 mm, and more preferably 0.10 to 0.30 mm.

The blade tip angle (cutting edge angle) is not particularly limited, and is preferably 15 to 55°, more preferably 25 to 50°, and even more preferably 35 to 45°. Within the above range, it is easy to properly cut the elastic member. The regeneration device 20 shown in the figure is an example where the cutting edge angle is 45°.

The blade portion 31 may be fixed to the regeneration device 20 (cutting unit 30) with a force that does not change the blade angle during cutting. For example, it may be fastened by a bolt or the like. The blade portion 31 may be fixed on one side as shown in FIG. 7A. The blade portion 31 may be fixed on both side portions across the elastic member when the regeneration device 20 is viewed from the free end side of the elastic member (for example, from the upper side of the device) by placing the blade portion 31 across the left and right cutting units 30 in FIG. 7A. As a result, the cutting precision is further improved.

The feed rate of the blade in the regeneration device 20 (that is, the speed of the relative movement) is not particularly limited as long as it is within a range in which the elastic member 3 can be appropriately cut, and is preferably 500 to 5000 mm/sec, more preferably 800 to 2000 mm/sec, and even more preferably 900 to 1500 mm/sec.

The slicing width of the elastic member 3 cut by the blade portion 31 is not particularly limited, and depends on the size of the elastic member used. The slicing width (the length of the elastic member in the lateral direction of the elastic member at the portion to be cut (the length of the dotted line C in FIG. 1B)) is preferably 0.8 to 5.0 mm, 0.8 to 3.5 mm, or the like.

The material of the blade portion 31 is not particularly limited, and a known material may be appropriately used depending on the elastic member to be cut. For example, stainless steel or iron may be used.

The regenerating device 20 includes the clamping member 21 that clamps at least a portion of the elastic member 3 from both side portions of the elastic member 3. The clamping member 21 clamps and fixes the elastic member 3 and suppresses elastic deformation due to the entry of the blade portion. It is sufficient that the clamping member 21 is disposed in a position where it can clamp the portion of the elastic member into which the blade portion 31 enters. The portion into which the blade portion enters refers to a portion in the vicinity of the contact point between the blade portion and the elastic member that can be clamped to suppress elastic deformation of the elastic member due to the entry of the blade portion. For example, it is a portion in the vicinity of the position where the blade portion enters, which is elastically deformed by the entry of the blade portion when both side portions of the elastic member are not clamped.

The clamping member 21 may clamp the entire elastic member. For example, as shown in FIGS. 7A and 7B, the clamping member 21 can clamp and fix the entire longitudinal region of the elastic member from both side portions by a member that is sufficiently longer than the longitudinal length of the elastic member 3. In addition, for example, the clamping member 21 clamps a region on the base portion 1 side rather than the position where the blade portion 31 enters.

The material of the clamping member 21 is not particularly limited, and known materials such as steel such as prehardened steel, stainless steel, and aluminum can be used.

The pressing force applied when the clamping member 21 clamps and fixes the elastic member 3 is not particularly limited, and may be changed as appropriate depending on the material of the elastic member. The elastic member 3 may be fixed with a force that is strong enough to suppress elastic deformation caused by the entry of the blade portion 31. The elastic member may be fixed with a force that does not unnecessarily deform when clamped. The method of fixing is also not particularly limited, and known methods such as fastening with a bolt may be used.

For example, the fastening force of the bolt when the clamping member 21 is fastened with a bolt to clamp the elastic member is preferably 5.0 to 50.0 N/m, 10.0 to 30.0 N/m, or 12.0 to 20.0 N/m. For example, the clamping member 21 preferably clamps the position corresponding to the portion where the blade portion enters with the above fastening force.

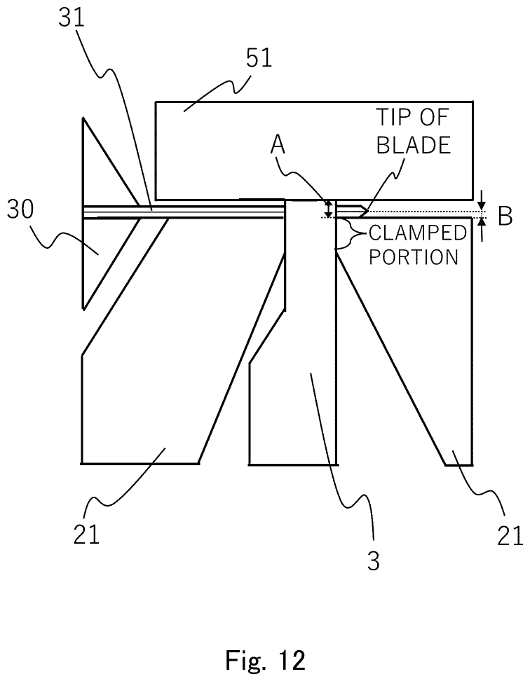

FIG. 12 is a further enlarged view of the vicinity of the tip of the elastic member 3 in FIG. 8B, which is a cross-sectional view of the cutting unit 30 and the clamping member 21 in the lateral direction of the elastic member. The portion of the elastic member 3 clamped by the clamping member 21 is defined as the clamped portion, and the length of the portion of the tip of the elastic member 3 protruding from the clamped portion to the outside of the clamping member 21 is defined as the protruding length A of the elastic member.

From the viewpoint of making it easier to suppress the elastic deformation of the elastic member 3, the length A is preferably 0.100 to 1.000 mm, more preferably 0.150 to 0.500 mm, and even more preferably 0.200 to 0.400 mm.

Furthermore, as shown in FIG. 12, the length (shortest distance) from the clamped portion of the elastic member by the clamping member 21 to the tip of the blade is defined as length B. From the viewpoint of making it easier to suppress the elastic deformation of the elastic member 3, the length B is preferably 0.200 mm or less, more preferably 0.150 mm or less, and even more preferably 0.130 mm or less. The smaller the lower limit, the better, but a length exceeding 0.000 mm is desirable to prevent interference between the blade and the clamped portion.

The length B is preferably greater than 0.000 mm and 0.200 mm or less, greater than 0.000 mm and 0.150 mm or less, or greater than 0.000 mm and 0.130 mm or less.

Furthermore, from the viewpoint of making it easier to suppress the elastic deformation of the elastic member 3, the value of B/A is preferably 0.10 to 0.75, more preferably 0.20 to 0.65, and even more preferably 0.40 to 0.60.

The cutting thickness of the tip of the elastic member 3 corresponding to A-B in FIG. 12 (the length from the base portion of the elastic member to the free end of the elastic member) may be changed as appropriate depending on the purpose of the regeneration, the length of the elastic member before regeneration, and the degree of deterioration of the elastic member, and is not particularly limited. The cutting thickness is preferably 0.05 to 1.00 mm, and more preferably 0.05 to 0.50 mm.

The pressing member 51 is a member that presses at least a portion of the tip surface of the elastic member 3 to suppress elastic deformation due to the movement of the blade portion. The regeneration device 20 includes the pressing member 51 that presses at least a portion of the tip surface of the elastic member 3 prior to the relative movement of the blade portion 31 from the end A to the end B. The pressing member 51 is not particularly limited as long as it can press the elastic member prior to the relative movement of the blade portion 31. The pressing force may be of a level that can suppress elastic deformation of the elastic member 3 due to the flipping up of the cut pieces.

The pressing member 51 may press the elastic member 3 in a direction opposite to the direction in which the cut pieces of the elastic member 3 are flipped up by the relative movement of the blade portion 31. This makes it easier to prevent the movement direction of the blade portion 31 from deviating toward the tip side. For example, the pressing member 51 presses the tip surface of the elastic member 3 from the direction facing the tip surface of the elastic member 3. The pressing member 51 may press the tip surface of the elastic member 3 toward the base portion 1 or toward the support member 300. In addition, for example, it is preferable that the free end side of the elastic member 3 has the tip surface 101, and the pressing member 51 presses the tip surface 101 from the direction facing the tip surface 101.

For example, an embodiment may be adopted in which a member having a certain degree of hardness is brought into contact with the tip surface 101 of the elastic member 3 and is provided at a position facing the tip surface. That is, it is preferable that the pressing member 51 moves in contact with the tip surface 101 of the elastic member 3, and that it is provided at a position facing the tip surface of the elastic member 3. By doing so, the pressing force can be changed appropriately according to the protruding length A of the elastic member 3. The pressing member 51 may or may not be biased by an elastic member such as a spring in the direction towards the base portion 1 relative to the elastic member 3.

The pressing member 51 may or may not be in contact with the clamping member 21, but it is preferable that it is not in contact with the clamping member.

When the blade portion is moved in the longitudinal direction of the elastic member, the cut pieces of the elastic member are sent to the space above and behind the blade portion as the cutting progresses. It is preferable that the pressing member 51 reduces or releases the pressure above and behind the tip of the blade portion 31 during the relative movement of the blade portion 31 so that the cut pieces of the elastic member are filled and the advance of the blade portion 31 is not hindered. As an example of the degree of reducing the pressure, the pressing force may be reduced to a level that does not hinder the advance of the blade portion 31.

From the viewpoint of regenerating the elastic member with high precision, it is preferable that the pressing member 51 releases the pressure so that the cut pieces can be easily sent behind the blade.

For example, as shown in FIG. 6, the pressing member 51 is preferably a disk-shaped member. The pressing member 51 may be fixed to the cutting unit 30 or may be supported by a shaft, but it is preferably supported by a shaft from the viewpoint of making it easier to press with a constant force. The pressing member 51 fixed to the cutting unit 30 may be a disk-shaped member or a convex member having an R-surface in the direction of the elastic member 3. The method of supporting is not particularly limited, and a known method using a bearing or the like may be adopted.

From the viewpoint of facilitating the reducing or releasing the pressure at the upper and rear sides of the tip of the blade portion 31, it is preferable that the pressing member 51 is a member that moves in accordance with (in synchronization with) the movement of the blade portion 31, for example by providing the pressing member 51 on the cutting unit 30 together with the blade portion 31, as shown in FIG. 6. It is preferable that the pressing member 51 moves while keeping a constant distance between the tip of the blade portion 31 and the pressing portion by the pressing member 51.

In the illustrated embodiment, the pressing member 51 is a disk-shaped roller member that is supported on the cutting unit 30 and rotates in contact with the tip surface of the elastic member as the cutting unit 30 moves relative to the blade portion 31. This is preferable because the pressing member 51 rotates in contact with the tip surface of the elastic member, making it easier to keep the pressing position and pressing force constant. The pressing force can also be controlled by the hardness of the pressing member 51 and the protruding length A of the elastic member 3.

As shown in FIG. 10B, the distance between the position corresponding to the cutting edge of the blade portion 31 and the contact point between the pressing member 51 and the elastic member 3 in the longitudinal direction of the tip of the elastic member 3 is defined as X. X is preferably 1 to 30 mm, more preferably 5 to 20 mm, and even more preferably 10 to 18 mm. In other words, it is preferable that the pressing member 51 presses the elastic member the distance X ahead of the movement of the blade portion 31. When the distance is in the above range, it becomes easier to suppress elastic deformation of the elastic member caused by the flipping up of the cut pieces.

When the pressing member 51 is a disk-shaped member, as shown in FIG. 10B, the distance between the center of the disk shape and the horizontal surface of the elastic member 3 is defined as Y. Y is preferably 5.0 to 100.0 mm, more preferably 10.0 to 70.0 mm, and even more preferably 20.0 to 50.0 mm.

When X and Y are equal to or less than the upper limits, it is easier to prevent the cut pieces from flipping up. When X and Y are equal to or more than the lower limits, it is easier to maintain good cutting resistance.

The value of X/Y is preferably 0.40 to 0.80, more preferably 0.50 to 0.70, and even more preferably 0.55 to 0.65.

For example, the elastic member may be pressed so that the difference between the radius of the disk-shaped member and the value Y is preferably 0.01 to 0.2 mm, and more preferably 0.05 to 0.15 mm. The difference between the radius of the disk-shaped member and the value Y indicates the degree of deformation of the pressing member due to pressing.

The width of the pressing member 51 (the length in the lateral direction of the elastic member 3) is not particularly limited as long as it can press the elastic member 3. Preferred examples of the width are 1 to 100 mm, 2 to 50 mm, and 5 to 20 mm.

The hardness of the pressing member 51 is not particularly limited as long as it can press the elastic member 3. The Wallace hardness of the pressing member 51 is preferably 70 to 90 degrees, and more preferably 75 to 80 degrees. When the hardness is in the above range, the pressing member is easily deformed appropriately, the effect of suppressing flipping-up is further improved, and an excessive increase in cutting resistance can be suppressed.

The Wallace hardness can be measured by using, for example, a Wallace Microhardness tester (manufactured by Wallace Instruments) as a measuring instrument according to the Japanese Industrial Standard (JIS) K6253-2:2012.

The material of the pressing member 51 is also not particularly limited, and a known material can be used. Examples of the material include rubber materials such as polyurethane rubber (ester-based polyurethanes, ether-based polyurethanes, and the like), silicone rubber, fluorocarbon rubber, and natural rubber; and

From the viewpoint of satisfying the Wallace hardness, rubber materials such as ester-based polyurethane are preferred.

The regeneration device 20 includes the biasing member 41 that comes into contact with a side portion of the end B of the elastic member 3 and biases the elastic member in the direction toward the end A. The biasing member 41 only needs to bias the end B to an extent that it can suppress elastic deformation in the longitudinal direction of the elastic member 3 (particularly elastic deformation at the tip side of the elastic member). For example, the biasing member may be shaped so as to be able to bias the clamped portion by the clamping member 21 and the region extending from the clamped portion to the free end side (tip side) of the elastic member 3 (FIG. 11B), or may be shaped so as to be able to bias the entire surface of the end B of the elastic member. The biasing member 41 is preferably shaped so as to be able to bias the clamped portion and the region extending from the clamped portion to the free end side of the elastic member 3.

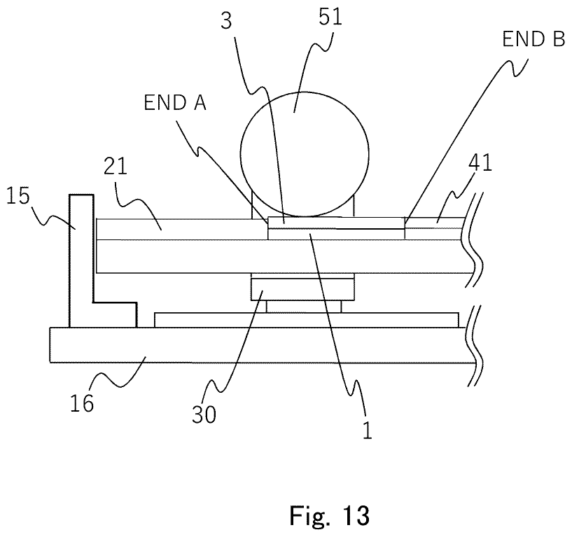

FIG. 13 is a cross-sectional view of the elastic member 3 in the longitudinal direction, at the position of the elastic member 3 clamped between the clamping members 21. The biasing member 41 is sandwiched between the clamping members 21 that clamp the elastic member 3, and biases the end B in the direction toward the end A (similar to FIG. 11B). The biasing member 41 itself may be an elastic member. The biasing member 41 is not fixed to the clamping member 21, that is, it is preferable that the biasing member 41 is loosely fitted in the clamping member 21.

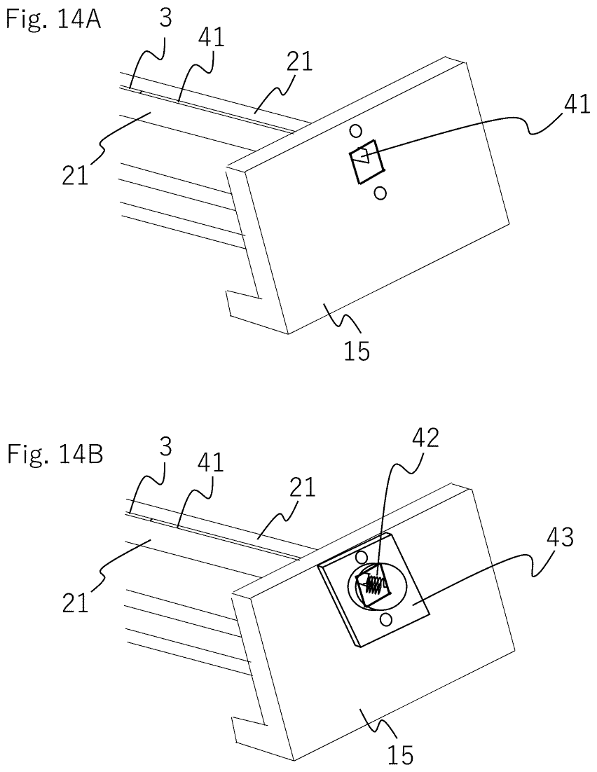

For example, as shown in FIG. 14A, the biasing member 41 is inserted between the clamping members 21 through a hole provided in the holding member 15. Then, as shown in FIG. 14B, a spring is inserted as the elastic member 42 so that the biasing member 41 can bias the end B, and the spring is pressed and fixed by a cover 43 so that the biasing member 41 biases the end B.

The shape of the biasing member 41 is not particularly limited, but for example, it is a plate-shaped member as shown in FIG. 13. If it is plate-shaped, it can be easily applied between the clamping members 21. As the plate-shaped member, for example, a shim plate or the like can be used according to the size of the gap between the clamping members 21. The shim plate is not particularly limited, and known metals such as iron, stainless steel, and copper can be used. For example, a cold-rolled steel plate can be used.

The thickness of the shim plate may be appropriately changed in consideration of the thickness of the elastic member 3 and the interval between the clamping members 21.

Examples of the shim plate include 0.1 to 2.0 mm and 0.2 to 1.0 mm. The length and height of the shim plate are not particularly limited, and may be selected according to the size of the elastic member 3 and the size of the device.

The biasing member 41 may bias the end B to such an extent that the elastic deformation of the elastic member 3 in the longitudinal direction can be suppressed. For example, when a spring is used as the biasing member 41 itself or as an elastic member for biasing the biasing member 41, the allowable load of the spring is preferably in the range of 10 to 100 N, more preferably 20 to 60 N. The spring constant is preferably 1.0 to 10.0 N/mm, more preferably 2.0 to 5.0 N/mm.

The material of the elastic member of the cleaning blade to be regenerated by the regeneration device is not particularly limited, and a known material may be used. For example, polyurethane rubber, silicone rubber, and the like may be used. The elastic member is preferably thermosetting polyurethane.

The Wallace hardness of the elastic member is not particularly limited, but is preferably 45 to 85 degrees, and more preferably 70 to 85 degrees. When the hardness is in the above range, it becomes easier to suppress the elastic deformation of the elastic member.

The length of the elastic member in the longitudinal direction and the thickness of the elastic member are not particularly limited, and those in the known ranges can be used.

### EXAMPLES

The present disclosure will be specifically explained below using examples. Note that the present disclosure is not limited to the following examples. In the following formulation, ‘parts’ refer to parts by mass unless otherwise indicated.

In this example, the following raw materials were used.

(1) 4,4′-Diphenylmethane diisocyanate

(Millionate MT (trade name), manufactured by Nippon Polyurethane Industry Co., Ltd.)

(2) Polybutylene adipate

(NIPPOLAN 4010 (trade name), manufactured by Nippon Polyurethane Industry Co., Ltd.)

(3) Polyhexylene adipate

(NIPPOLAN 164 (trade name), manufactured by Nippon Polyurethane Industry Co., Ltd.)

(4) 1,4-Butanediol (manufactured by Mitsubishi Chemical Corporation)

(5) Trimethylolpropane (manufactured by Mitsubishi Gas Chemical Company, Inc.)

(6) Urethanization catalyst (Kaolizer No. 25 (trade name), manufactured by Kao Corporation)

(7) Nucleation catalyst (P15 (trade name), manufactured by Air Products Japan, Inc.)

### Example 1

### Preparation of Thermosetting Polyurethane Raw Material Composition

A prepolymer was obtained by reacting 27.6 parts by mass of (1) 4,4′-diphenylmethane diisocyanate and 57.6 parts by mass of (2) polybutylene adipate (number average molecular weight: 2000) at 80° C. for 120 minutes under a nitrogen atmosphere.

Further, a curing agent was obtained by mixing 2.1 parts by mass of (4) 1,4-butanediol, 1.7 parts by mass of (5) trimethylolpropane, 12.4 parts by mass of (3) polyhexylene adipate (number average molecular weight: 1000), 0.003 parts by mass of (6) tin-based catalyst, and 0.034 parts by mass of (7) urethanation catalyst.

### Manufacturing of Cleaning Blade

A steel plate support member was prepared in advance. A phenolic resin adhesive was applied to one end surface of this support member. The support member was placed in a mold for cleaning blades, which is composed of an upper mold and a lower mold, with the adhesive-applied end protruding into the cavity. Next, a thermosetting polyurethane raw material composition prepared by mixing the prepolymer and the curing agent was injected into the cavity. This was heated at a temperature of 130° C. to cause a reaction and hardening, then demolded and cut to a specified size to produce a cleaning blade in which the elastic member was supported by a support member.

### Elastic Member Regeneration Device

The elastic member regeneration device 20 was prepared in the manner described above as one embodiment in FIGS. 6, 7A, 7B, 8A, 8B, 12, 13, 14A, and 14B. More specifically, the following was prepared. The length between the holding members 15 was set to 600 mm.

### Blade Portion 31

The following blade was used and fixed to the cutting unit 30 such that the angles A and B described below were obtained.

Blade type: High-speed steel (SKH material) (product name and material), double-edged, tip angle (cutting edge angle): 45°, triple polished (DLC-coated), blade thickness: 0.25 mm

Angle θA of blade: 45°

Angle of blade with respect to jig horizontal plane (formed angle θB): 5°

Blade clamping: As shown in FIG. 8B, the blade was clamped in the cutting unit 30 and both side portions of the blade were fastened with bolts.

### Clamping Member 21

The clamping member was prepared as shown below, and the elastic member was fixed to the blade portion 31 so that the slice width, protruding length A, and length B described below were obtained.

Material of clamping member 21: Free-cutting prehardened steel (model number: NAK55)

Pressing force: 14.7 N/m (clamped with M3 bolts fastened to this fastening force)

Slicing width: 2 mm

Protruding length A: 0.225 mm

Length B (length from clamped portion to tip of blade): 0.125 mm

### Pressing Member 51

As the pressing member 51, a member was used that was made by machining a standard urethane sheet made of polyester-based polyurethane (model number: UTM, manufactured by MISUMI Corporation) into a disk shape with a diameter of 57.0 mm and a width of 10 mm. The pressing member 51 was fixed to the cutting unit 30 at a position where X and Y in FIG. 10B had the following values. The pressing member 51 was brought into contact with the elastic member (the value of disk radius minus Y=0.1 mm), and fixed so that the pressing member 51 can rotate due to the movement of the cutting unit 30. By bringing it into contact in this way, the pressing member 51 can press the tip of the elastic member protruding from the clamping member 21 by the above-mentioned protruding length A. Accordingly, the pressing member 51 can press the elastic member the distance X ahead of the blade movement. The disk-shaped pressing member 51 was shaft-supported on the cutting unit 30 by a bearing cam follower (model number: CFUA3-10, manufactured by MISUMI Corporation), allowing the disk to rotate.

Material of pressing member 51: Polyester urethane (model number: UTM, manufactured by Misumi Corporation)

Wallace hardness: 80 degrees

Distance X: 17 mm

Distance Y: 28.4 mm

### Biasing Member 41

As the biasing member 41, a shim plate made of cold-rolled steel plate with a length of 50 mm, height of 10 mm, and thickness of 0.6 mm was passed between the clamping members 21 as shown in FIGS. 7B and 14B, and the end B of the elastic member was biased toward the end A using the spring 42 and the cover 43. As the spring 42, a spring with a spring constant of 2.9 N/mm and an allowable load of 30 to 50 N (model number WL18-35, manufactured by Misumi Corporation) was used.

### Cutting

As described above, in the regeneration device 20 to which the elastic member was fixed, the cutting unit 30 was moved at a blade feed rate of 1000 mm/sec using a Robo Cylinder (model number RCS3-CT8C, manufactured by IAI Corporation) to cut the elastic member from the end A to the end B, thereby obtaining a regenerated cleaning blade.

### Comparative Example 1

In Example 1, the pressing force of the clamping member 21 was set to 0 N/m. In addition, no pressing member or biasing member was used. Except for the above, a regenerated cleaning blade was obtained in the same manner as in Example 1.

### Comparative Example 2

In Example 1, no pressing member or biasing member was used. Except for the above, a regenerated cleaning blade was obtained in the same manner as in Example 1.

### Comparative Example 3

In Example 1, no biasing member was used. Except for the above, a regenerated cleaning blade was obtained in the same manner as in Example 1.

### Comparative Example 4

In Example 1, the pressing force of the clamping member 21 was set to 0 N/m, the protruding length A was set to 2 mm, and the length B was set to 0.125 mm. Except for the above, a regenerated cleaning blade was obtained in the same manner as in Example 1.

### Evaluation of Cutting Precision

The regenerated cleaning blade obtained was evaluated by the following procedure.

The pressing member was removed from the regeneration device used for cutting so that no object was present vertically above the cut surface. In this state, an ultra-high-speed, high-precision laser dimension measuring device (model number: LS-9000, manufactured by Keyence Corporation) was used to measure the height of the cut surface at the end A, the midpoint in the longitudinal direction, and the end B of the regenerated elastic member. The height was calculated by measuring the distance from a reference position in the LS-9000 to the tip on the free end side of the elastic member using the LS-9000. Specifically, the LS-9000 was placed crosswise with respect to the cleaning blade installed in the regeneration device, and the height of the cut surface at the end A, the midpoint, and the end B was measured by repeating measurements while moving the LS-9000 in parallel from the end A to the end B. The LS-9000 was set so that the distance from the reference position to the upper surface of the clamping member 21 was 10.125 mm.

The distance that the blade advanced toward the end B, with the end A being 0, was taken as P (mm) for the total length of the cleaning blade, which was 450 mm.

### Image Evaluation

The obtained cleaning blade for electrophotographic devices was installed in a laser beam printer (LBP-672C: manufactured by Canon Inc.) and the cleaning performance was evaluated by forming images continuously 500 times at a low temperature (10° C.). The obtained images were visually inspected and the images were evaluated according to the following criteria. The results are shown in Table 1.

A: No image defects due to poor cleaning were observed

B: Minor image defects due to poor cleaning were observed

C: Significant image defects due to poor cleaning were observed

TABLE 1

| | Height (mm) | | | Distance P | Image |
|---|---|---|---|---|---|
| | End A | Midpoint | End B | (mm) | Evaluation |
| Example 1 | 10.000 | 9.915 | 9.825 | 450 | A |
| Comparative | 9.775 | 9.775 | 9.775 | 0 | C |
| Example 1 | | | | | |
| Comparative | 10.001 | 9.775 | 9.775 | 100 | C |
| Example 2 | | | | | |
| Comparative | 10.000 | 9.914 | 9.775 | 450 | C |
| Example 3 | | | | | |
| Comparative | 10.000 | 9.000 | 8.125 | 450 | C |
| Example 4 | | | | | |

In Comparative Example 1, the blade could not enter into the side surface of the elastic member on the end A side, and cutting was not possible.

In Comparative Example 2, the blade exited on the tip surface side at a position 100 mm away from the end A, and the elastic member could not be cut from that position to the end B.

According to at least one aspect of the present disclosure, a cleaning blade regeneration device can be provided that can regenerate cleaning blades with reduced wiping performance with high precision. According to at least one aspect of the present disclosure, a cleaning blade regeneration method can be provided that restores the wiping performance of a cleaning blade with reduced wiping performance. Furthermore, according to at least one aspect of the present disclosure, a method for manufacturing regenerated cleaning blades can be provided that can manufacture regenerated cleaning blades with wiping performance equivalent to that of new cleaning blades.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A regeneration device for a cleaning blade provided in an electrophotographic image forming apparatus, wherein
the cleaning blade comprises an elastic member and a support member that supports the elastic member,
when a side of the cleaning blade that contacts a surface of a cleaning target member is defined as a tip side of the cleaning blade, the elastic member has a plate-shaped portion at least at the tip side, which has a main surface that faces the cleaning target member and a tip surface that forms a tip-side edge together with the main surface,
the regeneration device comprises a blade portion for cutting at least a portion of the elastic member including the tip surface in a longitudinal direction of the elastic member,
the regeneration device is configured to cause the blade portion to enter into the elastic member from a side portion of the plate-shaped portion of the elastic member at one end A in the longitudinal direction of the elastic member to move relatively toward the other end B in the longitudinal direction, thereby cutting at least the portion of the elastic member including the tip surface,
the regeneration device comprises:
a clamping member for the elastic member;
a biasing member that contacts the end B of the elastic member and biases the elastic member in a direction toward the end A; and
a pressing member that presses at least a portion of the tip surface of the elastic member,
the clamping member is configured to clamp at least a portion of the elastic member from both side portions of the elastic member in a cross-sectional view taken in a direction perpendicular to the longitudinal direction of the elastic member,
the clamping member is disposed at a position where it can clamp at least a portion of the elastic member into which the blade portion enters, and a position of the clamping member relative to the elastic member is fixed, and
the pressing member presses at least a portion of the tip surface of the elastic member toward a side opposite to the tip side of the elastic member prior to the relative movement of the blade portion from the end A to the end B.

2. The regeneration device for a cleaning blade according to claim 1, wherein the pressing member presses at least a portion of the tip surface of the elastic member toward the side opposite to the tip side of the elastic member prior to the relative movement of the blade portion from the end A to the end B, thereby preventing an advancing direction of the blade portion from deviating toward the tip surface side due to the movement of the blade portion.

3. The regeneration device for a cleaning blade according to claim 1, wherein the pressing member reduces or releases the pressing at a position above and behind a tip of the blade portion during the relative movement of the blade portion.

4. The regeneration device for a cleaning blade according to claim 1, wherein the clamping member is a member that clamps an entire longitudinal region of the elastic member from both side portions.

5. The regeneration device for a cleaning blade according to claim 1, wherein a length B from the clamped portion of the elastic member by the clamping member to the tip of the blade portion is 0.200 mm or less.

6. The regeneration device for a cleaning blade according to claim 1, wherein the pressing member is a disc-shaped roller member that rotates in contact with the tip surface of the elastic member.

7. The regeneration device for a cleaning blade according to claim 1, wherein the pressing member presses the elastic member in a direction opposite to a direction in which a cut piece of the elastic member is flipped up by the relative movement of the blade portion.

8. A regeneration method for a cleaning blade provided in an image forming apparatus using an electrostatic transfer process, wherein
the cleaning blade comprises an elastic member and a support member that supports the elastic member,
when a side of the cleaning blade that contacts a surface of a cleaning target member is defined as a tip side of the cleaning blade, the elastic member has a plate-shaped portion at least at the tip side, which has a main surface that faces the cleaning target member and a tip surface that forms a tip-side edge together with the main surface,
the method comprising:
a step of fixing the elastic member to a regeneration device for the cleaning blade; and
a step of cutting at least a portion of the elastic member including the tip surface by the regeneration device,
the regeneration device comprises a blade portion for cutting at least the portion of the elastic member including the tip surface in a longitudinal direction of the elastic member,
the regeneration device is configured to cause the blade portion to enter into the elastic member from a side portion of the plate-shaped portion of the elastic member at one end A in the longitudinal direction of the elastic member to move relatively toward the other end B in the longitudinal direction, thereby cutting at least the portion of the elastic member including the tip surface,
the regeneration device comprises:
a clamping member for the elastic member;
a biasing member that contacts the end B of the elastic member and biases the elastic member in a direction toward the end A; and
a pressing member that presses at least a portion of the tip surface of the elastic member,
the clamping member is configured to clamp at least a portion of the elastic member from both side portions of the elastic member in a cross-sectional view taken in a direction perpendicular to the longitudinal direction of the elastic member,
the clamping member is disposed at a position where it can clamp at least a portion of the elastic member into which the blade portion enters, and a position of the clamping member relative to the elastic member is fixed, and
the pressing member presses at least a portion of the tip surface of the elastic member toward a side opposite to the tip side of the elastic member prior to the relative movement of the blade portion from the end A to the end B.

9. A regeneration device for a cleaning blade provided in an electrophotographic image forming apparatus, wherein
the cleaning blade comprises an elastic member and a support member supporting the elastic member,
when a side of the cleaning blade that contacts a surface of a cleaning target member is defined as a tip side of the cleaning blade, the elastic member has a plate-shaped portion at least at the tip side, which has a main surface that faces the cleaning target member and a tip surface that forms a tip-side edge together with the main surface,
the regeneration device comprises a blade portion for cutting at least a portion of the elastic member including the tip surface in a longitudinal direction of the elastic member,
the regeneration device is configured to cause the blade portion to enter into the elastic member from a side portion of the plate-shaped portion of the elastic member at one end A in the longitudinal direction of the elastic member to move relatively toward the other end B in the longitudinal direction, thereby cutting at least the portion of the elastic member including the tip surface, and
the regeneration device further comprises:
a clamping member that clamps at least a portion of the elastic member from both side portions of the elastic member in a cross-sectional view taken in a direction perpendicular to the longitudinal direction of the elastic member;
a biasing member that contacts the end B of the elastic member and biases the elastic member in a direction toward the end A; and
a pressing member disposed on the tip surface of the elastic member to press the tip prior to the movement of the blade portion and prevent an advancing direction of the blade portion from deviating toward the tip side due to the movement of the blade portion.
